(19) United States
(12) Patent Application Publication
(10) Pub. No.: US 2010/0046201 A1
(43) Pub. Date: Feb. 25, 2010

(54) Electronic Assembly and Backlight Module

(76) Inventors: Cheng WANG, Hsinchu (TW); Jin-Shu HUANG, Hsinchu (TW)

Correspondence Address: HDLS Patent & Trademark Services, P.O. BOX 220746, CHANTILLY, VA, 20153-0746, US

(21) Appl. No.: 12/333,302

(22) Filed: Dec. 11, 2008

(30) Foreign Application Priority Data
Aug. 25, 2008 (TW) 097132439

(51) Int. Cl. G09F 13/00; F21V 21/00

(52) U.S. Cl. 362/97.1; 362/249.02

(57) ABSTRACT

An electronic assembly includes a thermally-conductive substrate, a circuit board device and a plurality of light emitting diode (LED) devices. The circuit board device is disposed on the thermally-conductive substrate. The LED devices are disposed on the thermally-conductive substrate. The LED device includes a plurality of electrical connection portions and at least one thermal connection portion. The electrical connection portions are electrically connected to the circuit board device. The thermal connection portion is thermally connected to the thermally-conductive substrate. The connection locations of the circuit board device connected to the electrical connection portions and the connection location of the thermally-conductive substrate connected to the thermal connection portion are at a same plane. In addition, a backlight module applying the electronic assembly is also provided.

### BACKGROUND

1. Technical Field

The present invention relates to an electronic assembly and particularly relates to a backlight module using the electronic assembly.

2. Description of the Related Art

FIG. 1 is a schematic cross-sectional view of a conventional electronic assembly. Referring to FIG. 1, the conventional electronic assembly 100 includes a metal substrate 110, a circuit board 120 and a plurality of light emitting diode (LED) packages 130. The circuit board 120 is disposed on the metal substrate 110. The circuit board 120 includes a circuit layer 122 and a dielectric layer 124.

The LED packages 130 are disposed on the circuit board 120. Each of the LED packages 130 includes two leads 132, a heat sink 134 and a LED chip 136. The LED chip 136 is disposed on the heat sink 134 and electrically connected to the leads 132 through two bonding wires (not shown). The leads 132 of the LED packages 130 are electrically connected to the circuit layer 122 of the circuit board 120.

When the LED chip 136 emits light and generates heat, the heat is transmitted to the outside of the LED package 130 through the corresponding heat sink 134. However, because of the circuit board 120 having the dielectric layer 124, the heat generated by the LED chip 136 may not be effectively transmitted to the metal substrate 110. In other words, on the whole, due to the relatively big thermal resistance, the circuit board 120 does not easily transmit the heat such that the efficiency of heat dissipation of the conventional electronic assembly 100 is relatively low.

### BRIEF SUMMARY

The present invention is directed to provide an electronic assembly of which the efficiency of heat dissipation is relatively high.

The present invention is also directed to provide a backlight module using the above electronic assembly of which the efficiency of heat dissipation is relatively high.

Other advantages and objectives of the present invention can be further comprehended through the technical features disclosed in the present invention.

In order to achieve one or part of or all the objectives or other objectives, in an embodiment of the present invention, an electronic assembly includes a thermally-conductive substrate, a circuit board device and a plurality of LED devices. The circuit board device is disposed on the thermally-conductive substrate. The LED devices are disposed on the thermally-conductive substrate. The LED device includes a plurality of electrical connection portions and at least one thermal connection portion. The electrical connection portions are electrically connected to the circuit board device. The thermal connection portion is thermally connected to the thermally-conductive substrate. The connection locations of the circuit board device connected to the electrical connection portions and the connection location of the thermally-conductive substrate connected to the thermal connection portion are at a same plane.

In order to achieve one or part of or all the objectives or other objectives, in an embodiment of the present invention, a backlight module includes a light guide plate and the above mentioned electronic assembly. The light guide plate has a light incident surface and a light emitting surface. The electronic assembly is adjacent to the light guide plate. The LED device is capable of emitting a light beam passing through the light incident surface.

Because the thermal connection portion of the LED device is thermally connected to the thermally-conductive substrate, the heat generated by the LED device is transmitted to the thermally-conductive substrate through the thermal connection portion of the LED device such that the heat is transmitted to the external environment through the thermally-conductive substrate. Therefore, compared to the conventional art, the efficiency of heat dissipation of the electronic assembly of the embodiment of the present invention is relatively high.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute part of this specification. The drawings illustrate embodiments of the invention and, together with the description, serve to explain the principles of the invention.

FIG. 1 is a schematic cross-sectional view of a conventional electronic assembly.

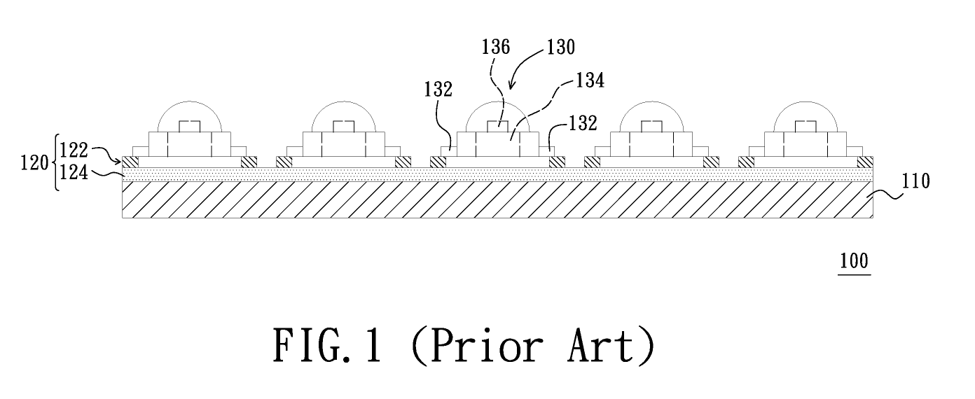

FIG. 2A is a schematic top view of a backlight module according to a first embodiment of the present invention.

FIG. 2B is a schematic cross-sectional view of the backlight module of FIG. 2A taken along a line A-A.

FIG. 3A is a schematic top view of an electronic assembly according to a second embodiment of the present invention.

FIG. 3B is a schematic cross-sectional view of the electronic assembly of FIG. 3A taken along a line B-B.

FIG. 4 is a schematic top view of another electronic assembly according to the second embodiment of the present invention.

FIG. 5 is a schematic cross-sectional view of an electronic assembly according to a third embodiment of the present invention.

FIG. 6 is a schematic cross-sectional view of an electronic assembly according to a fourth embodiment of the present invention.

FIG. 7 is a schematic cross-sectional view of an electronic assembly according to a fifth embodiment of the present invention.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

### First Embodiment

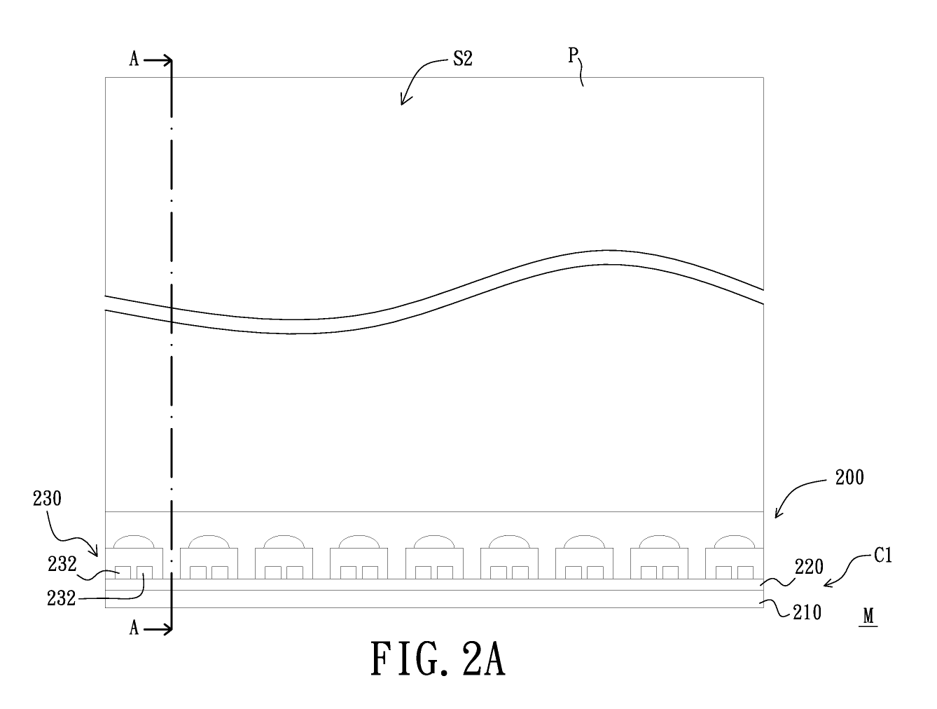

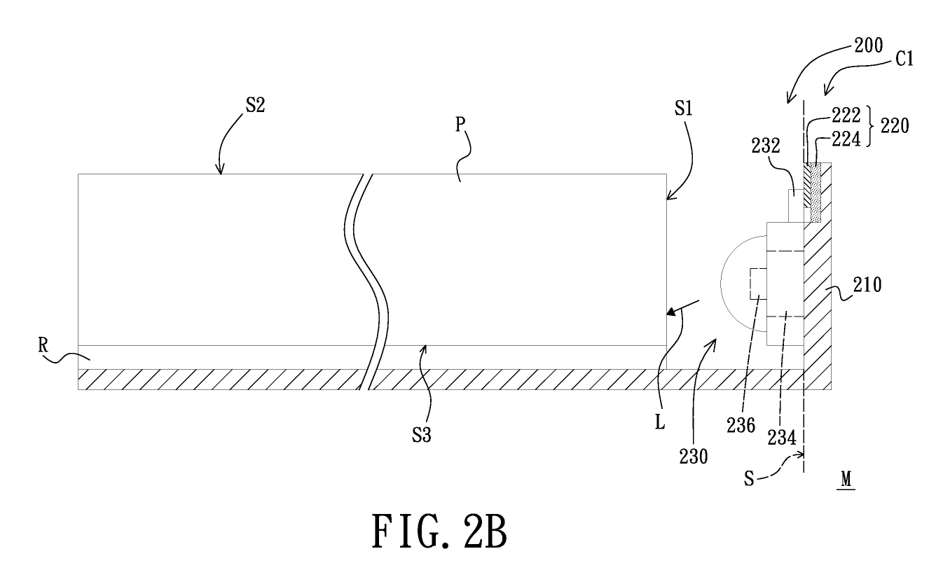

FIG. 2A is a schematic top view of a backlight module according to the first embodiment of the present invention. FIG. 2B is a schematic cross-sectional view of the backlight module of FIG. 2A taken along a line A-A. Referring to FIGS. 2A and 2B, the backlight module M of the present embodiment includes a light guide plate P and an electronic assembly 200. The light guide plate P has a light incident surface S1 and a light emitting surface S2. The electronic assembly 200 is adjacent to the light guide plate P.

The electronic assembly 200 includes a thermally-conductive substrate 210, a circuit board device C1 and a plurality of LED devices 230. The material of the thermally-conductive substrate 210 of the present embodiment may be aluminum, for example. The circuit board device C1 of the present embodiment includes a first circuit board 220. The first circuit board 220 is disposed on the thermally-conductive substrate 210. The first circuit board 220 includes a first circuit layer 222 and a first dielectric layer 224.

The LED devices 230 may be disposed on the thermally-conductive substrate 210 in an array. The LED device 230 includes a plurality of electrical connection portions 232 and at least one thermal connection portion 234. The electrical connection portions 232 of the LED device 230 are electrically connected to the first circuit layer 222 of the first circuit board 220 of the circuit board device C1. The thermal connection portion 234 of the LED device 230 is thermally connected to the thermally-conductive substrate 210. The connection locations of the first circuit board 220 of the circuit board device C1 connected to the electrical connection portions 232 and the connection location of the thermally-conductive substrate 210 connected to the thermal connection portion 234 are at a same plane S.

In this embodiment, the LED device 230 may be a LED package further including a LED chip 236. Each of the electrical connection portions 232 of the LED device 230 may be a lead, and the thermal connection portion 234 of the LED device 230 may be a heat sink. The LED chip 236 is disposed on the corresponding thermal connection portion 234 and electrically connected to the corresponding electrical connection portions 232 through a plurality of corresponding bonding wires (not shown). In addition, the electrical connection portions 232 of the LED device 230 are located at the same side of the LED device 230.

When the LED device 230 operates a light beam L emitted by the LED chip 236 of the LED device 230 passes through the light incident surface S1 of the light guide plate P and heat is generated by the LED chip 236. The light beam L is reflected by a reflective sheet R disposed on a bottom surface S3 of the light guide plate P and leaves the light guide plate P through the light emitting surface S2 of the light guide plate P. At this time, the heat generated by the corresponding LED chip 236 is transmitted to the thermally-conductive substrate 210 through the thermal connection portion 234 of the LED device 230 such that the heat is transmitted to the external environment through the thermally-conductive substrate 210. Therefore, compared to the conventional art, the efficiency of heat dissipation of the electronic assembly 200 of the backlight module M of the present embodiment is relatively high.

### Second Embodiment

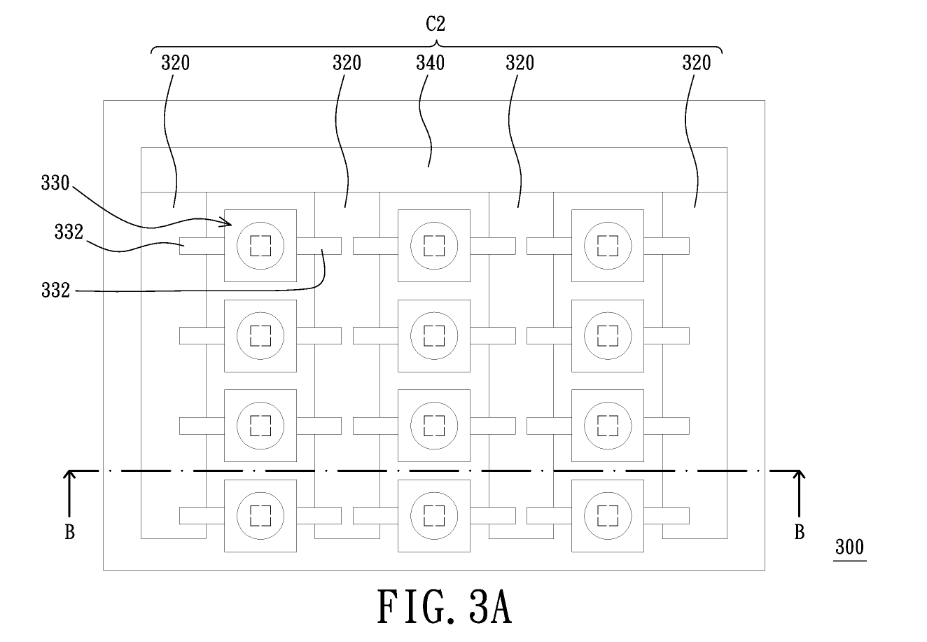

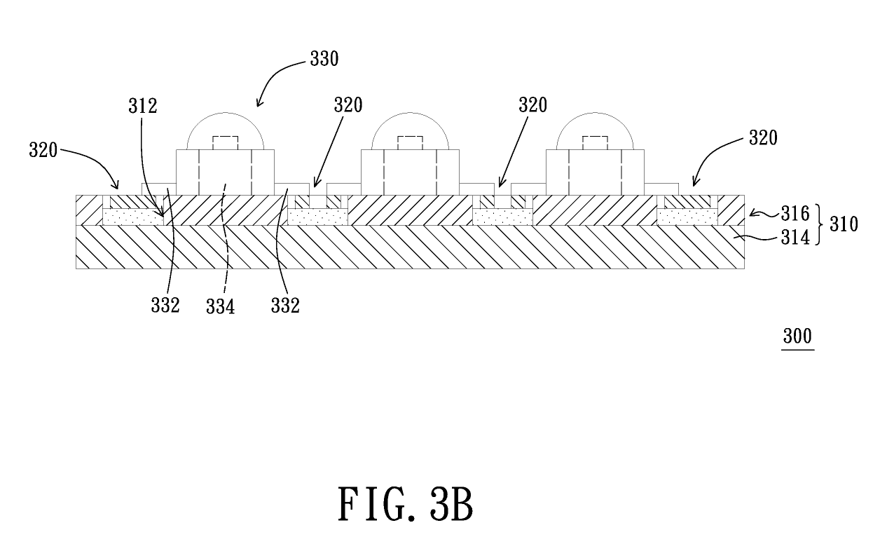

FIG. 3A is a schematic top view of an electronic assembly according to a second embodiment of the present invention. FIG. 3B is a schematic cross-sectional view of the electronic assembly of FIG. 3A taken along a line B-B. Referring to FIGS. 3A and 3B, the differences between the electronic assembly 300 of the present embodiment and the electronic assembly 200 of the first embodiment are that the circuit board device C2 of the electronic assembly 300 includes a plurality of first circuit boards 320 and a medium electrical connection element 340 and that the thermally-conductive substrate 310 is a composite substrate. The thermally-conductive substrate 310 has a plurality of trenches 312. The first circuit board 320 is disposed in the trench 312. The first circuit boards 320 are parallel with each other. The LED device 330 is adjacent to at least one of the first circuit boards 320. The electrical connection portion 332 of the LED device 330 is electrically connected to one of the first circuit boards 320. In this embodiment, the LED device 330 is located between two adjacent first circuit boards 320. The electrical connection portions 332 of the LED device 330 are disposed on opposite sides of the LED device 330 and electrically connected to two adjacent first circuit boards 320 respectively.

The medium electrical connection element 340 may be a second circuit board which is disposed on the thermally-conductive substrate 310 and electrically connects the first circuit boards 320.

The thermally-conductive substrate 310 includes a thermally-conductive base 314 and a thermally-conductive layer 316 disposed on the thermally-conductive base 314. The material of the thermally-conductive base 314 differs from that of the thermally-conductive layer 316. In this embodiment, a thermal conductivity coefficient of the thermally-conductive base 314 is less than that of the thermally-conductive layer 316. The thermal connection portion 334 of the LED device 330 is disposed on the thermally-conductive layer 316. In addition, the material of the thermally-conductive base 314 may be aluminum and the material of the thermally-conductive layer 316 may be copper.

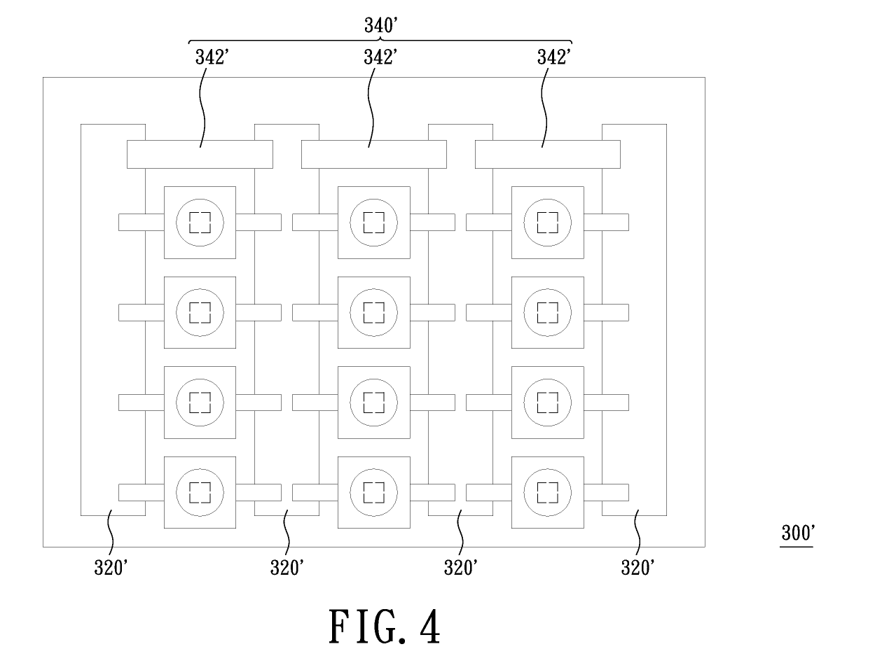

FIG. 4 is a schematic top view of another electronic assembly according to the second embodiment of the present invention. Referring to FIG. 4, the medium electrical connection element 340′ of an electronic assembly 300′ includes a plurality of connectors 342′. The connector 342′ electrically connects two adjacent first circuit boards 320′.

### Third Embodiment

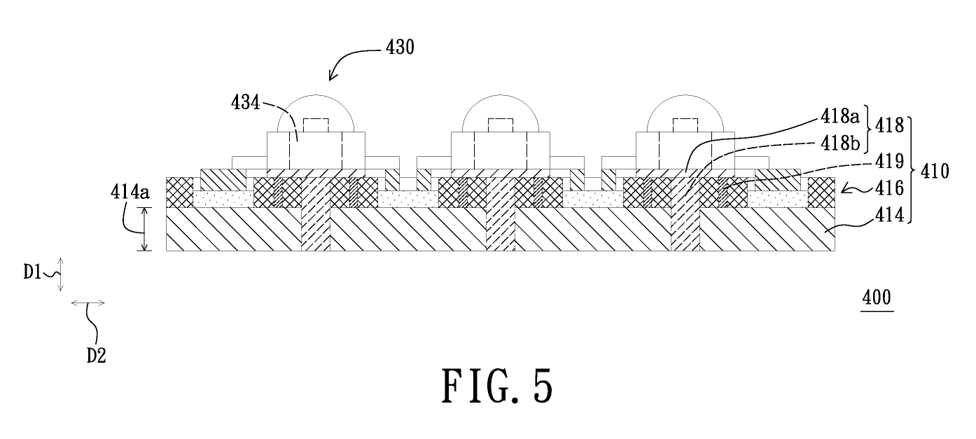

FIG. 5 is a schematic cross-sectional view of an electronic assembly according to a third embodiment of the present invention. Referring to FIG. 5, the differences between the electronic assembly 400 of the present embodiment and the electronic assembly 300 of the second embodiment are that a thermally-conductive substrate 410 of the electronic assembly 400 further includes a plurality of thermally-conductive through elements 418 and a plurality of thermally-conductive vias 419 passing through the thermally-conductive layer 416. The thermally-conductive through element 418 passes through the thermally-conductive layer 416 and is thermally connected to a thermally-conductive base 414. In this embodiment, the thermally-conductive through element 418 is a nail-shaped element including a head portion 418a and a penetrating portion 418b. The penetrating portion 418b of the thermally-conductive through element 418 passes through the thermally-conductive layer 416 and the thermally-conductive base 414. The thermal connection portion 434 of the LED device 430 is disposed on the head portion 418a of the thermally-conductive through element 418. In addition, the thermally-conductive via 419 is thermally connected to the thermally-conductive base 414 and the head portion 418a of the thermally-conductive through element 418.

It should be pointed out that the thermally-conductive base 414 has a first thermal conductivity coefficient in a first direction D1 that is parallel to a thickness 414a of the thermally-conductive base 414 and a second thermal conductivity coefficient in a second direction D2 that is perpendicular to the thickness 414a of the thermally-conductive base 414. The thermally-conductive layer 416 has a third thermal conductivity coefficient in the first direction D1 and a fourth thermal conductivity coefficient in the second direction D2. The first thermal conductivity coefficient is greater than the third thermal conductivity coefficient and the second thermal conductivity coefficient is less than the fourth thermal conductivity coefficient. In other words, in the first direction D1, the thermal resistance of the thermally-conductive base 414 is less than that of the thermally-conductive layer 416 and in the second direction D2 that is perpendicular to the first direction D1, the thermal resistance of the thermally-conductive base 414 is greater than that of the thermally-conductive layer 416.

In this embodiment, the material of the thermally-conductive base 414 is metal, such as copper or aluminum. The material of the thermally-conductive layer 416 is graphite. The material of the thermally-conductive through element 418 is metal, such as copper or aluminum. As described above, the efficiency of heat dissipation of the thermally-conductive substrate 410 is more improved.

### Fourth Embodiment

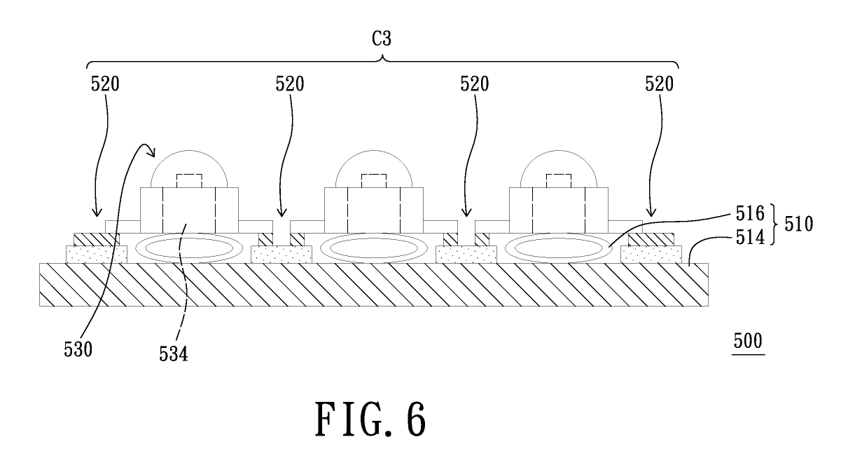

FIG. 6 is a schematic cross-sectional view of an electronic assembly according to a fourth embodiment of the present invention. Referring to FIG. 6, the difference between the electronic assembly 500 of the present embodiment and the electronic assembly 400 of the third embodiment is that a thermally-conductive substrate 510 of the electronic assembly 500 includes a thermally-conductive base 514 and at least one heat pipe 516 (three heat pipes 516 are shown in FIG. 6). The heat pipes 516 are disposed on the thermally-conductive base 514. The first circuit boards 520 of the circuit board device C3 are disposed on the thermally-conductive base 514. The thermal connection portion 534 of the LED device 530 is disposed on the corresponding heat pipe 516.

### Fifth Embodiment

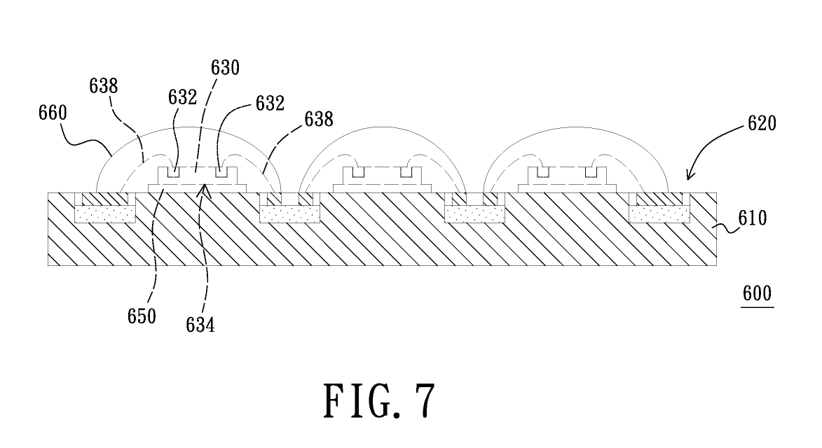

FIG. 7 is a schematic cross-sectional view of an electronic assembly according to a fifth embodiment of the present invention. Referring to FIG. 7, the LED device 630 of the electronic assembly 600 is an LED chip. The electrical connection portion 632 of the LED device 630 may be a pad which is electrically connected to one of first circuit boards 620 through a bonding wire 638. In addition, the thermal connection portion 634 of the LED device 630 may be the back surface of the LED chip.

It should be pointed out that if the material of the thermally-conductive substrate 610 is aluminum, the thermal expansion coefficient of the LED device 630 such as the LED chip and that of the thermally-conductive substrate 610 do not match. Therefore, a medium substrate 650 may be disposed between the LED device 630 and the thermally-conductive substrate 610. The thermal expansion coefficient of the medium substrate 650 is similar to the thermal expansion coefficient of the LED chip, and the medium substrate 650 is used as a buffer for reducing thermal stress between the LED device 630 and the thermally-conductive substrate 610. The material of the medium substrate 650 may be silicon (Si) or aluminum nitride (AlN).

In addition, the electronic assembly 600 further includes a plurality of encapsulants 660. The encapsulants 660 encapsulate the LED devices 630 and the corresponding bonding wires 638 respectively in order to protect the LED devices 630 and the bonding wires 638.

In summary, the electronic assembly and the backlight module using the electronic assembly of each of the embodiments of the present invention have at least one of the following advantages or other advantages:

1. Because the thermal connection portion of the LED device is thermally connected to the thermally-conductive substrate, the heat generated by the LED device is transmitted to the thermally-conductive substrate through the thermal connection portions of the LED device such that the heat is transmitted to the external environment through the thermally-conductive substrate. Therefore, compared to the conventional art, the efficiency of heat dissipation of the electronic assembly of the embodiment of the present invention is relatively high.

2. The thermally-conductive substrate may be the composite substrate and therefore, on the whole, the efficiency of heat dissipation of the electronic assembly may be easily improved according to the requirement of a designer.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An electronic assembly comprising:
a thermally-conductive substrate;
a circuit board device disposed on the thermally-conductive substrate; and
a plurality of light emitting diode devices disposed on the thermally-conductive substrate, wherein the light emitting diode device comprises:
a plurality of electrical connection portions electrically connected to the circuit board device, and
at least one thermal connection portion thermally connected to the thermally-conductive substrate, wherein the connection locations of the circuit board device connected to the electrical connection portions and the connection location of the thermally-conductive substrate connected to the thermal connection portion are at a same plane.

2. The electronic assembly according to claim 1, wherein the thermally-conductive substrate is a composite substrate.

3. The electronic assembly according to claim 2, wherein the thermally-conductive substrate comprises a thermally-conductive base and a thermally-conductive layer disposed on the thermally-conductive base, and the material of the thermally-conductive base differs from that of the thermally-conductive layer.

4. The electronic assembly according to claim 3, wherein the thermal conductivity coefficient of the thermally-conductive base is less than that of the thermally-conductive layer, and the thermal connection portion of the light emitting diode device is disposed on the thermally-conductive layer.

5. The electronic assembly according to claim 4, wherein the material of the thermally-conductive base is aluminum and the material of the thermally-conductive layer is copper.

6. The electronic assembly according to claim 3, wherein the thermally-conductive substrate further comprises a plurality of thermally-conductive through elements, the thermally-conductive through element passes through the thermally-conductive layer and is thermally connected to the thermally-conductive base, the thermal connection portion of the light emitting diode device is disposed on the thermally-conductive through element, the thermally-conductive base has a first thermal conductivity coefficient in a first direction that is parallel to a thickness of the thermally-conductive base and a second thermal conductivity coefficient in a second direction that is perpendicular to the thickness of the thermally-conductive base, and the thermally-conductive layer has a third thermal conductivity coefficient in the first direction and a fourth thermal conductivity coefficient in the second direction, the first thermal conductivity coefficient is greater than the third thermal conductivity coefficient, and the second thermal conductivity coefficient is less than the fourth thermal conductivity coefficient.

7. The electronic assembly according to claim 6, wherein the material of the thermally-conductive base is metal, the material of the thermally-conductive layer is graphite, and the material of the thermally-conductive through element is metal.

8. The electronic assembly according to claim 6, wherein the thermally-conductive substrate further comprises a plurality of thermally-conductive vias passing through the thermally-conductive layer, and the thermally-conductive via is thermally connected to the thermally-conductive base and the thermally-conductive through element.

9. The electronic assembly according to claim 2, wherein the thermally-conductive substrate comprises a thermally-conductive base and at least one heat pipe, the circuit board device is disposed on the thermally-conductive base, the heat pipe is disposed on the thermally-conductive base, and the thermal connection portion of one of the light emitting diode devices is disposed on the heat pipe.

10. The electronic assembly according to claim 1, wherein the circuit board device comprises a plurality of first circuit boards and a medium electrical connection element, the first circuit boards are parallel with each other, the light emitting diode device is disposed adjacent to at least one of the first circuit boards, the electrical connection portion of the light emitting diode device is electrically connected to one of the first circuit boards, and the medium electrical connection element is disposed on the thermally-conductive substrate and electrically connects the first circuit boards.

11. The electronic assembly according to claim 10, wherein the thermally-conductive substrate has a plurality of trenches and the first circuit board is disposed in the trench.

12. The electronic assembly according to claim 10, wherein the medium electrical connection element is a second circuit board.

13. The electronic assembly according to claim 10, wherein the medium electrical connection element comprises a plurality of connectors and the connector electrically connects two adjacent first circuit boards.

14. The electronic assembly according to claim 1, wherein the electrical connection portions of the light emitting diode device are located at the same side of the light emitting diode device.

15. The electronic assembly according to claim 1, wherein the electrical connection portions of the light emitting diode device are located at opposite sides of the light emitting diode device.

16. A backlight module comprising:
a light guide plate having a light incident surface and a light emitting surface; and
an electronic assembly adjacent to the light guide plate, comprising:
a thermally-conductive substrate;
a circuit board device disposed on the thermally-conductive substrate; and
a plurality of light emitting diode devices disposed on the thermally-conductive substrate, wherein the light emitting diode device is capable of emitting a light beam passing through the light incident surface and comprises:
a plurality of electrical connection portions electrically connected to the circuit board device, and
at least one thermal connection portion thermally connected to the thermally-conductive substrate, wherein the connection locations of the circuit board device connected to the electrical connection portions and the connection location of the thermally-conductive substrate connected to the thermal connection portion are at a same plane.

17. The backlight module according to claim 16, wherein the thermally-conductive substrate has at least one trench and the circuit board device is disposed in the trench.

18. The backlight module according to claim 16, wherein the thermally-conductive substrate is a composite substrate.

19. The backlight module according to claim 18, wherein the thermally-conductive substrate comprises a thermally-conductive base and a thermally-conductive layer disposed on the thermally-conductive base, and the material of the thermally-conductive base differs from that of the thermally-conductive layer.

20. The backlight module according to claim 19, wherein the thermal conductivity coefficient of the thermally-conductive base is less than that of the thermally-conductive layer, and the thermal connection portion of the light emitting diode device is disposed on the thermally-conductive layer.
